(19) United States
(12) Patent Application Publication
(10) Pub. No.: US 2022/0406329 A1
(43) Pub. Date: Dec. 22, 2022

(54) INFORMATION PROCESSING DEVICE, INFORMATION PROCESSING METHOD, AND INFORMATION PROCESSING PROGRAM

(71) Applicant: FUJIFILM CORPORATION, Tokyo (JP)

(72) Inventors: Michitaka KONDO, Tokyo (JP); Yutaka OISHI, Tokyo (JP); Takashi MIYAMOTO, Tokyo (JP); Terue WATANABE, (US); Koji MATSUMURA, Tokyo (JP); Yuko UNO, Tokyo (JP)

(21) Appl. No.: 17/821,800

(22) Filed: Aug. 24, 2022

Related U.S. Application Data
(63) Continuation of application No. PCT/JP2021/007768, filed on Mar. 1, 2021.

(30) Foreign Application Priority Data
Mar. 2, 2020 (JP) 2020-035309

(51) Int. Cl. G11B 5/008; G11B 15/26

(52) U.S. Cl. CPC G11B 5/00813; G11B 15/26

(57) ABSTRACT

An information processing device (10) includes at least one processor. The processor divides data with a certain size or larger, which is specified on the basis of a read-out history, into a plurality of pieces of partial data, and performs control to distribute and record the plurality of pieces of partial data with respect to a plurality of magnetic tapes, respectively.

### CROSS REFERENCE TO RELATED APPLICATIONS

This application is a continuation application of International Application No. PCT/JP2021/007768, filed Mar. 1, 2021, the disclosure of which is incorporated herein by reference in its entirety. Further, this application claims priority from Japanese Patent Application No. 2020-035309, filed on Mar. 2, 2020, the disclosure of which is incorporated herein by reference in its entirety.

### BACKGROUND

### 1. Technical Field

The disclosed technique relates to an information processing device, an information processing method, and an information processing program.

### 2. Description of the Related Art

The following techniques are known as techniques related to processing of recording data on a plurality of magnetic tapes provided in a tape library. For example, JP2016-115377A discloses that the number of tape devices that are available at a point in time of read-out with respect to the number of tape drives that are available at a point in time of writing a file requested to be written to a plurality of tapes is predicted, data of the file requested to be written is divided into a predetermined number of segments such that the time required to read out the file is reduced, on the basis of the number of the predicted available drives, and the segment is written to the corresponding tape.

Meanwhile, JP1992-124721A (JP-H04-124721A) discloses that a series of sequential data transferred from a host computer is accumulated in a buffer and is divided into units of a predetermined amount of data, and the divided blocks are transferred to and recorded on a plurality of drive devices on which respective tapes are mounted, in parallel.

### SUMMARY

The following methods are conceivable as data backup operations. For example, a method of storing data with a relatively high read-out frequency in a storage such as a flash memory or an HDD that requires a relatively short time from reception of a data read-out request to completion of data read-out (hereinafter, referred to as a read-out time), or a method of storing data that has a relatively low read-out frequency but needs to be saved, in a storage with a low capacity unit price such as a magnetic tape, is conceivable for the operations.

However, there is a probability that data recorded on the magnetic tape and assumed to have a relatively low read-out frequency may be relatively frequently requested to be read out. It is preferable that data with a high read-out frequency can be read out in as short a read-out time as possible. However, the response time (time from the reception of the read-out request to the start of read-out) in a case where reading out the data recorded on the magnetic tape is often longer than that of the flash memory or the like, and the read-out time may be relatively long.

The disclosed technique has been made in view of the above circumstances, and an object thereof is to provide an information processing device, an information processing method, and an information processing program capable of shortening a read-out time for data recorded on a magnetic tape and assumed to be read out at a relatively high frequency.

According to the disclosed technique, there is provided an information processing device comprising: at least one processor, in which the processor divides data with a certain size or larger, which is specified on the basis of a read-out history, into a plurality of pieces of partial data, and performs control to distribute and record the plurality of pieces of partial data with respect to a plurality of magnetic tapes, respectively.

The processor may divide data, which is read out a certain number of times or more within a certain period, into the plurality of pieces of partial data.

The processor may make a size of at least one of the plurality of pieces of partial data different from a size of the other piece of partial data in a case where the number of tape drives available when the pieces of partial data are read out from the plurality of magnetic tapes on which the pieces of partial data are recorded is smaller than the number of magnetic tapes on which the pieces of partial data are recorded.

The processor may determine the number of divisions in a case where the data is divided into the plurality of pieces of partial data, on the basis of a requested value of a data transfer rate in a case where the data is read out from the magnetic tape.

The processor may determine the number of divisions in a case where the data is divided into the plurality of pieces of partial data, on the basis of an assumed value of an error rate in a case where the data is read out from the magnetic tape.

The processor may determine the number of divisions in a case where the data is divided into the plurality of pieces of partial data, on the basis of the number of information processing devices available at a point in time of data read-out, the information processing devices processing data read out from the magnetic tape.

According to the disclosed technique, there is provided an information processing method executed by a processor provided in an information processing device, the method comprising: dividing data with a certain size or larger, which is selected on the basis of a read-out history, into a plurality of pieces of partial data; and performing control to distribute and record the plurality of pieces of partial data with respect to a plurality of magnetic tapes, respectively.

According to the disclosed technique, there is provided an information processing program for causing a processor provided in an information processing device to execute a process comprising: dividing data with a certain size or larger, which is selected on the basis of a read-out history, into a plurality of pieces of partial data; and performing control to distribute and record the plurality of pieces of partial data with respect to a plurality of magnetic tapes, respectively.

According to the disclosed technique, it is possible to shorten a read-out time for data recorded on a magnetic tape and assumed to be read out at a relatively high frequency.

### BRIEF DESCRIPTION OF THE DRAWINGS

Exemplary embodiments according to the technique of the present disclosure will be described in detail based on the following figures, wherein:

FIG. 1 is a diagram showing a configuration of a recording and reproducing system according to an embodiment of the disclosed technique;

FIG. 2 is a diagram illustrating a hardware configuration of an information processing device according to the embodiment of the disclosed technique;

FIG. 3 is a diagram showing an example of a read-out log according to the embodiment of the disclosed technique;

FIG. 4 is a functional block diagram showing an example of a functional configuration of the information processing device according to the embodiment of the disclosed technique;

FIG. 5 is a flowchart showing an example of a flow of recording processing according to the embodiment of the disclosed technique;

FIG. 6 is a diagram showing an example of the recording processing according to the embodiment of the disclosed technique;

FIG. 7 is a diagram showing an example of read-out processing according to the embodiment of the disclosed technique;

FIG. 8 is a diagram showing an example of a data transfer rate at a time of data read-out according to the embodiment of the disclosed technique;

FIG. 9 is a diagram showing an example of a data transfer rate in a system provided with a plurality of types of information processing according to the embodiment of the disclosed technique;

FIG. 10 is a time chart showing an example of timing at which tape drives according to the embodiment of the disclosed technique read out pieces of partial data in parallel; and

FIG. 11 is a time chart showing another example of timing at which the tape drives according to the embodiment of the disclosed technique read out the pieces of partial data in parallel.

### DETAILED DESCRIPTION

Hereinafter, an example of an embodiment of the disclosed technique will be described with reference to the drawings. The same or equivalent constituent elements and parts are given the same reference numerals in each drawing, and overlapping description will not be repeated as appropriate.

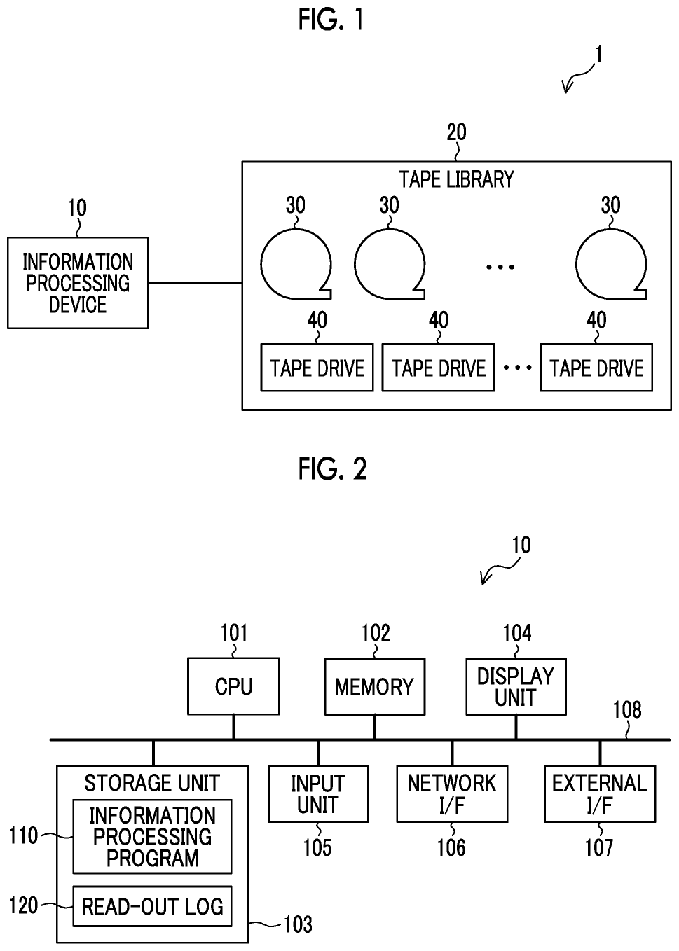

FIG. 1 is a diagram showing a configuration of a recording and reproducing system 1 according to the embodiment of the disclosed technique. The recording and reproducing system 1 includes an information processing device 10 and a tape library 20. The tape library 20 comprises a plurality of slots (not shown) and a plurality of tape drives 40, and a magnetic tape 30 is stored in each slot. Each tape drive 40 is connected to the information processing device 10. An example of the magnetic tape 30 includes a linear tape-open (LTO) tape.

In a case where data is recorded (written) or read out with respect to the magnetic tape 30, a target magnetic tape 30 is loaded into a predetermined tape drive 40 from the slot. In a case where the recording or read-out of data with respect to the magnetic tape 30 loaded in the tape drive 40 is completed, the magnetic tape 30 is taken out from the tape drive 40 and stored in a predetermined slot.

The information processing device 10 performs control to record and read out data with respect to the magnetic tape 30. In the present embodiment, in a case where data is recorded on the magnetic tape 30, the information processing device 10 divides data with a high read-out frequency and a certain size or larger, out of data to be recorded, into a plurality of pieces of partial data, and performs control to distribute and record the plurality of pieces of partial data with respect to a plurality of the magnetic tapes, respectively.

FIG. 2 is a diagram showing a hardware configuration of the information processing device 10. The information processing device 10 includes a central processing unit (CPU) 101, a memory 102 serving as a temporary storage area, and a non-volatile storage unit 103. In addition, the information processing device 10 includes a display unit 104, such as a liquid crystal display, an input unit 105, such as a keyboard and a mouse and, a network interface (I/F) 106 connected to a network, and an external I/F 107 to which the tape drive 40 is connected. The CPU 101, the memory 102, the storage unit 103, the display unit 104, the input unit 105, the network I/F 106, and the external I/F 107 are connected to a bus 108.

The storage unit 103 is realized by a storage medium such as a hard disk drive (HDD), a solid state drive (SSD), or a flash memory. The storage unit 103 stores an information processing program 110. The CPU 101 reads out the information processing program 110 from the storage unit 103 and then develops the information processing program 110 into the memory 102, and executes the information processing program 110. An example of the information processing device 10 includes a server computer. The CPU 101 is an example of the processor in the disclosed technique.

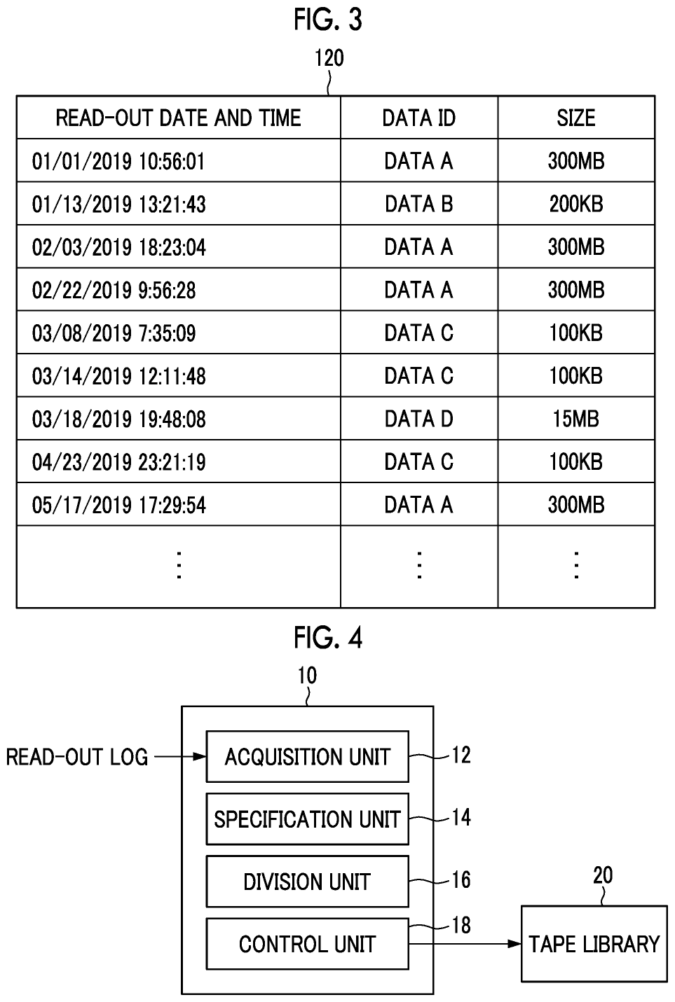

A read-out log 120 is stored in the storage unit 103. The read-out log 120 is information indicating a read-out history of data recorded on the magnetic tape 30 loaded in any of the tape drives 40. FIG. 3 is a diagram showing an example of the read-out log 120. In the read-out log 120, data read out from the magnetic tape 30 is recorded in association with the data ID, which is data identification information, the data size, and the read-out date and time.

FIG. 4 is a functional block diagram showing an example of a functional configuration of the information processing device 10. The information processing device 10 includes an acquisition unit 12, a specification unit 14, a division unit 16, and a control unit 18.

The acquisition unit 12 acquires the read-out log 120 stored in the storage unit 103 in a case where data is recorded on the magnetic tape 30.

The specification unit 14 determines whether or not data to be recorded includes data of which the read-out frequency is a threshold value or greater and of which the size is a threshold value or greater, on the basis of the read-out log 120, and specifies such data in a case where the data to be recorded includes such data. The read-out frequency with the threshold value or greater means that the data is read out a certain number of times or more within a certain period. The threshold values for the read-out frequency and the data size can be appropriately set by a user and are not particularly limited.

The division unit 16 divides the data specified as data of which the read-out frequency is the threshold value or greater and of which the size is the threshold value or greater, out of data to be recorded, into a plurality of pieces of partial data. The division unit 16 may determine the number of data divisions such that the number of pieces of partial data is, for example, a predetermined number. Alternatively, the division unit 16 may determine the number of data divisions such that the size of each of the plurality of pieces of partial data has a predetermined value or less. The plurality of pieces of partial data may have the same size, or may include a piece of partial data having a size different from the other piece of partial data.

The control unit 18 performs control to distribute and record the plurality of pieces of partial data with respect to the plurality of magnetic tapes in a case where the piece of partial data is recorded on the magnetic tape 30. For example, in a case where data is divided into three pieces of partial data, the control unit 18 performs control to distribute and record the three pieces of partial data with respect to three magnetic tapes 30 different from each other. In a case where the control unit 18 performs the above control, the control unit 18 supplies the tape library 20 with data to be recorded and information indicating a recording instruction.

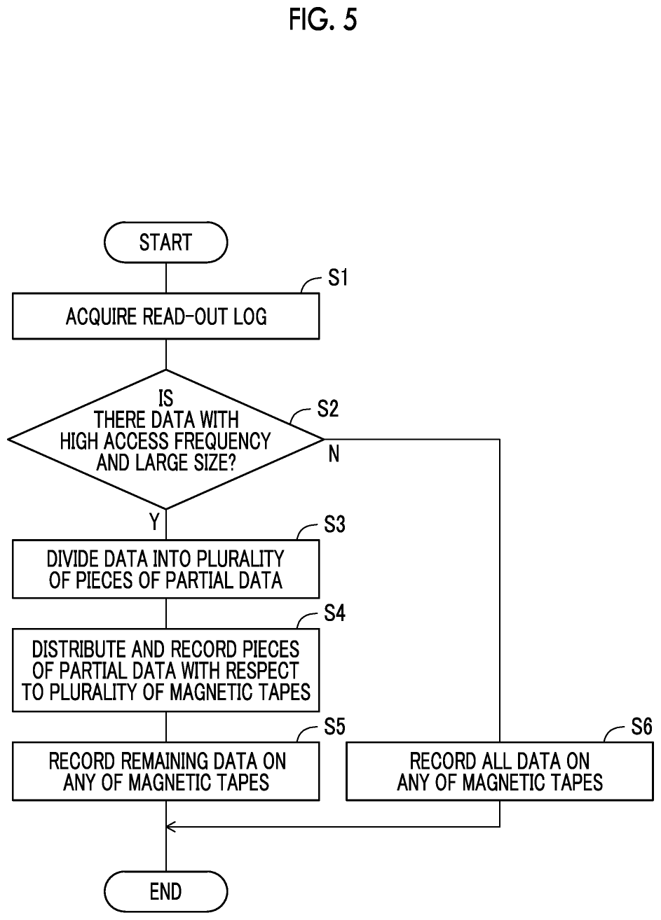

The action of the information processing device 10 will be described below. FIG. 5 is a flowchart showing an example of a flow of recording processing that is implemented by the CPU 101 executing the information processing program 110. The information processing program 110 is executed, for example, in a case where an instruction to execute recording processing is input by the user via the input unit 105. It is assumed that data to be recorded and the read-out log 120 related to the data to be recorded are stored in the storage unit 103.

In step S1, the acquisition unit 12 acquires the read-out log 120 stored in the storage unit 103. In step S2, the specification unit 14 determines whether or not data to be recorded includes data of which the read-out frequency is a threshold value or greater and of which the size is a threshold value or greater, on the basis of the read-out log 120, and specifies such data in a case where the specification unit 14 determines that the data to be recorded includes such data. In a case where the specification unit 14 determines that the data to be recorded includes data of which the read-out frequency is the threshold value or greater and of which the size is the threshold value or greater, the process proceeds to step S3. On the other hand, in a case where the specification unit 14 determines that the data to be recorded does not include data of which the read-out frequency is the threshold value or greater and of which the size is the threshold value or greater, the process proceeds to step S6.

In step S3, the division unit 16 divides the data of which the read-out frequency is the threshold value or greater and of which the size is the threshold value or greater, which is specified in step S2, into a plurality of pieces of partial data. The division unit 16 divides the data such that the size of each of the divided data has, for example, a predetermined value or less.

In step S4, the control unit 18 performs control to distribute and record the pieces of partial data generated in step S3 with respect to the plurality of magnetic tapes 30, respectively. That is, the control unit 18 controls the tape drive 40 such that the piece of partial data is recorded on each of the magnetic tapes 30 having a number corresponding to the number of data divisions (the number of pieces of partial data). At this time, the control unit 18 may perform control to record the piece of partial data from the beginning of the magnetic tape 30 in a longitudinal direction. The beginning of the magnetic tape in the longitudinal direction indicates a portion that is first accessible in a case where the magnetic tape is pulled out from a magnetic tape cartridge, and is sometimes referred to as beginning of tape (BOT).

In step S5, the control unit 18 performs control to record the remaining data except for the data divided into the pieces of partial data, out of data to be recorded, on any one of the magnetic tapes 30. The recording destination of the remaining data is not particularly limited, and the remaining data may be recorded on one specific magnetic tape 30 or the remaining data may be recorded on two or more specific magnetic tapes 30.

In a case where data to be recorded does not include data of which the read-out frequency is a threshold value or greater and of which the size is the threshold value or greater, the control unit 18 performs control to record the data to be recorded, on any of the magnetic tapes 30, in step S6. In this case, the recording destination of data is not particularly limited.

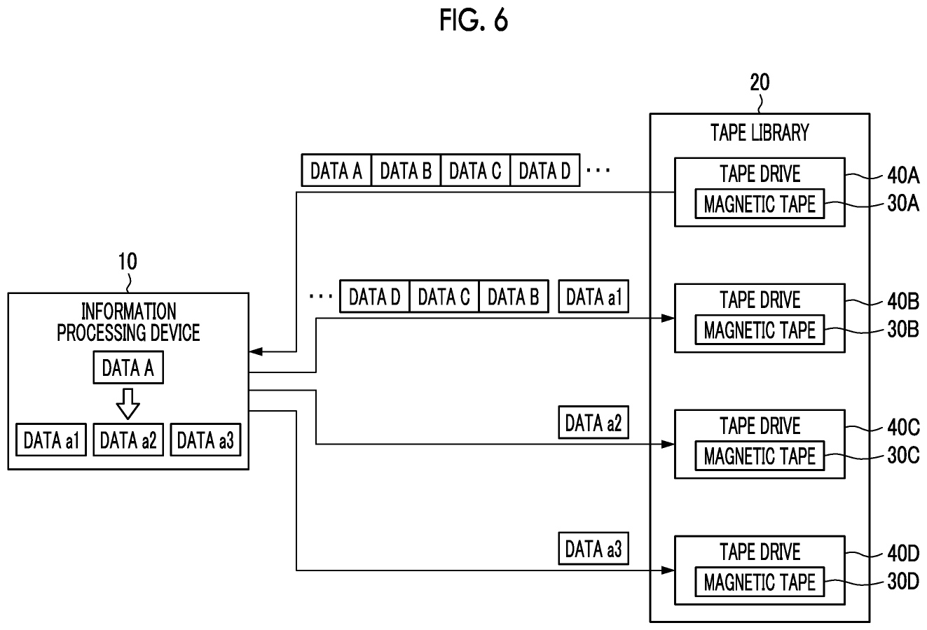

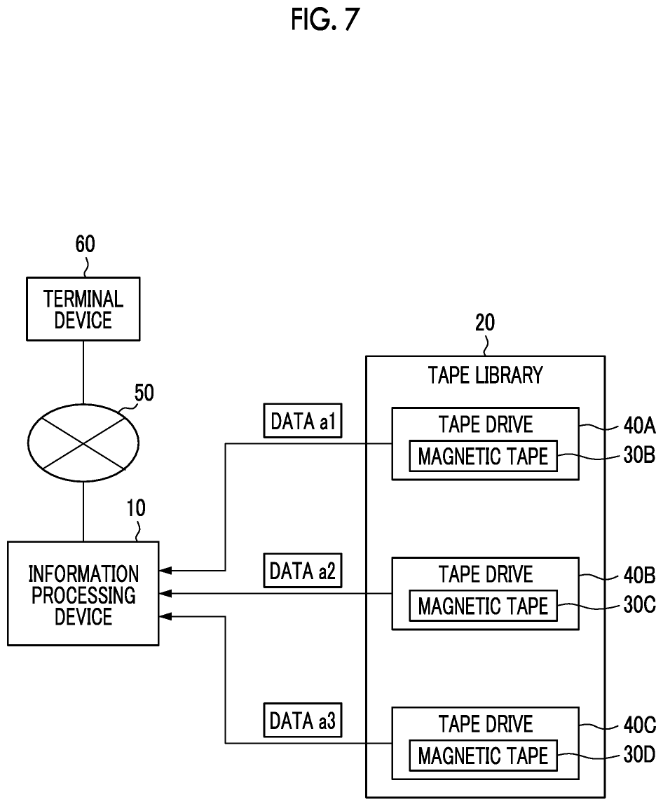

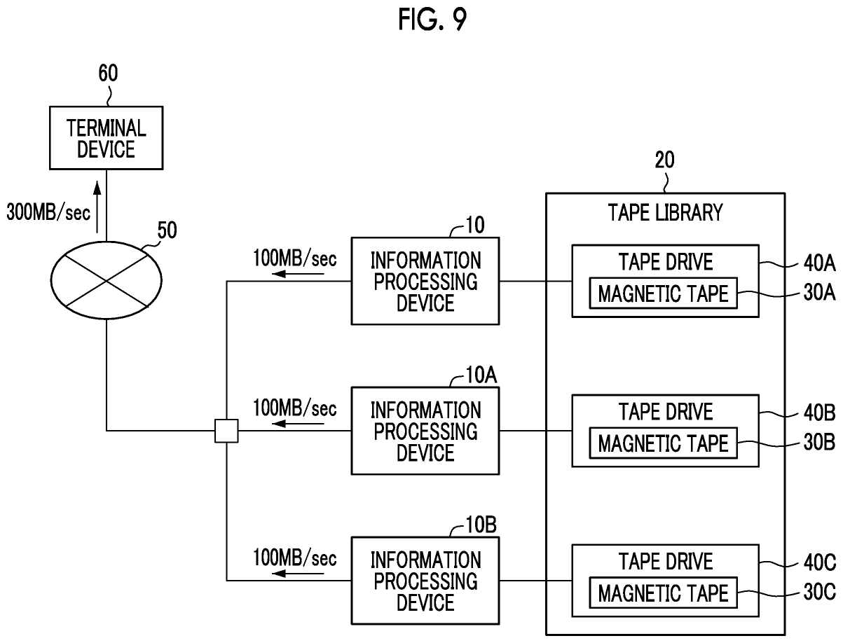

FIG. 6 is a diagram showing an example of recording processing in a case of migrating data recorded on a magnetic tape to another magnetic tape. In FIG. 6, in order to distinguish the plurality of tape drives 40 and the plurality of magnetic tapes 30, identification codes A to D are given at the ends of the reference numerals. The same applies to FIGS. 7 and 9 referred to in the following description. In the following description, a case where data recorded on the magnetic tape 30A is migrated to the magnetic tapes 30B, 30C, and 30D is exemplified.

The magnetic tape 30A is loaded into the tape drive 40A, and the data recorded on the magnetic tape 30A is read out by the information processing device 10 and stored in the storage unit 103, prior to the recording processing. The information processing device 10 specifies data A as data of which the read-out frequency is the threshold value or greater and the size is the threshold value or greater, out of data A, B, C, D, . . . read out from the tape drive 40A, on the basis of the read-out log 120 illustrated in FIG. 3. The information processing device 10 divides the data A into, for example, three pieces of partial data a1, a2, and a3. The information processing device 10 records the pieces of partial data a1, a2, and a3 on three magnetic tapes different from each other, and supplies the tape library 20 with a recording instruction as to which magnetic tapes 30 the remaining data B, C, D, . . . should be recorded on, together with the data B, C, D, . . . to be recorded and the pieces of partial data a1, a2, and a3.

In response to the recording instruction supplied from the information processing device 10, in the tape library 20, the magnetic tapes 30B, 30C, and 30D are taken out from slots (not shown) and loaded into tape drives 40B, 40C, and 40D, respectively. The tape drive 40B records the piece of partial data a1 and the data B, C, D, . . . on the magnetic tape 30B. The tape drive 40C records the piece of partial data a2 on the magnetic tape 30C. The tape drive 40D records the piece of partial data a3 on the magnetic tape 30D. In a system in which the number of tape drives provided in the tape library 20 is smaller than the number of pieces of partial data (the number of data divisions), the pieces of partial data are sequentially recorded on the magnetic tapes sequentially loaded in the tape drive by a tape changer (not shown).

FIG. 7 is a diagram showing an example of read-out processing in which the information processing device 10 reads out the piece of partial data from the magnetic tape on which the piece of partial data is recorded. In a case where a request to read out the data A divided into a plurality of pieces of partial data is given from a terminal device 60 connected to the information processing device 10 via a network 50, the information processing device 10 instructs the tape library 20 to read out the pieces of partial data a1, a2, and a3 generated by dividing the data A. In response to the received read-out instruction, the tape library 20 takes out the magnetic tapes 30B, 30C, and 30D on which the pieces of partial data a1, a2, and a3 are recorded, from the slots (not shown), and loads the magnetic tapes 30B, 30C, and 30D into the tape drives 40A, 40B, and 40C, respectively. The tape drives 40A, 40B, and 40C perform processing of reading out the pieces of partial data a1, a2, and a3 from the magnetic tapes 30B, 30C, and 30D, respectively, and of transferring the pieces of partial data a1, a2, and a3 to the information processing device 10, in parallel.

As described above, the information processing device 10 divides the data of which the read-out frequency is the threshold value or greater and of which the size is the threshold value or greater, into the plurality of pieces of partial data, and performs control to distribute and record the plurality of pieces of partial data with respect to the plurality of magnetic tapes 30, respectively. With this, it is possible to perform parallel read-out in which the plurality of tape drives are linked, in a case where data recorded on the magnetic tape 30 is read out. Accordingly, it is possible to shorten the data read-out time, as compared with a case of reading out data recorded on one magnetic tape without dividing the data. In addition, the piece of partial data is recorded from the beginning of the magnetic tape 30 in the longitudinal direction, so that it is possible to shorten the response time at the time of data read-out.

In the above description, the aspect in which data, which actually has a history in which the data is read out a certain number of times or more within a certain period and which is specified by referring to the read-out log 120, is used as data to be divided has been exemplified, but the disclosed technique is not limited to this aspect. For example, the data to be divided may be specified by analogy based on the read-out log 120. For example, in a case where it is known from the read-out log 120 that the read-out frequency of data with a specific extension is the threshold value or greater, data with the extension may be used as the data to be divided as long as the size thereof is the threshold value or greater, regardless of whether or not the data is actually read out.

Further, in the above description, the aspect in which the number of data divisions is determined such that the number of pieces of partial data is a predetermined number, and the aspect in which the number of data divisions is determined such that the size of each of the plurality of pieces of partial data has a predetermined value or less have been exemplified, but the disclosed technique is not limited to these aspects. The number of divisions in a case where data is divided into a plurality of pieces of partial data may be determined as follows.

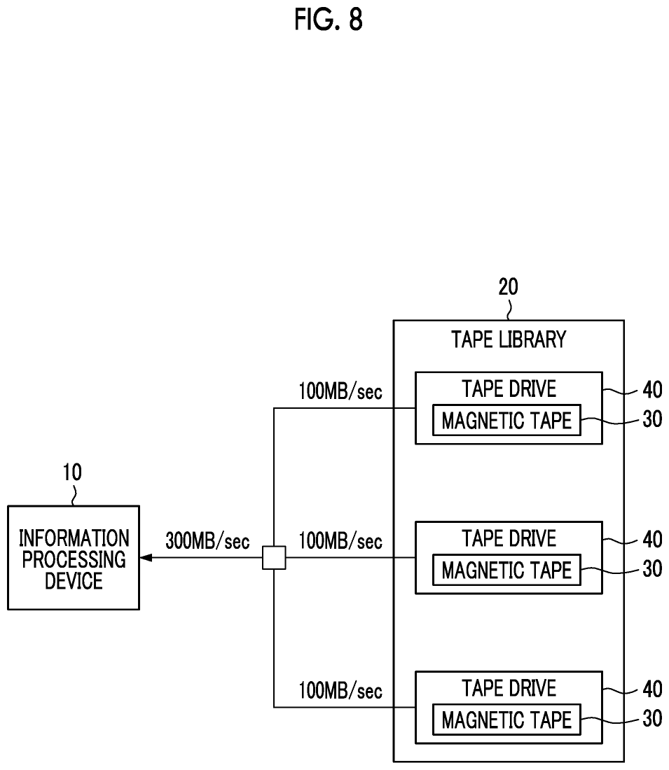

The information processing device 10 may determine the number of divisions in a case where data is divided into a plurality of pieces of partial data, for example, on the basis of a requested value of a data transfer rate (a transfer rate of data transferred to the information processing device 10 from the tape library 20) in a case where data is read out from the magnetic tape 30. For example, in a case where the data transfer rate between each of the tape drives 40 and the information processing device 10 is 100 MB/sec, and the requested value of the transfer rate of data transferred to the information processing device 10 from the tape library 20 is 300 MB/sec, the number of data divisions is preferably equal to or greater than three (300 MB/sec/100 MB/sec). With this, as shown in FIG. 8, it is possible to read out three or more pieces of partial data in parallel, and it is possible to satisfy the transfer rate request. The requested value of the data transfer rate may be input by, for example, the user via the input unit 105.

Alternatively, the information processing device 10 may determine the number of divisions in a case where data is divided into a plurality of pieces of partial data, on the basis of an assumed value of an error rate in a case where the data is read out from the magnetic tape 30 housed in the tape library 20. The higher the error rate in a case where the data recorded on the magnetic tape 30 is read out to the information processing device 10 is, the lower the effective transfer rate of data transferred to the information processing device 10 from the tape library 20 is. The higher the assumed value of the error rate is, the greater the number of data divisions is made, so that the number of parallel processing in a case where the pieces of partial data are read out in parallel from the plurality of magnetic tapes 30 on which the pieces of partial data are recorded can be increased. Therefore, it is possible to compensate for the decrease in transfer rate caused by an error at the time of data read-out. The assumed value of the error rate may be input by, for example, the user via the input unit 105.

Alternatively, the information processing device 10 may determine the number of divisions in a case where data is divided into a plurality of pieces of partial data, on the basis of the number of information processing devices available at a point in time of data read-out, which process data read out from the magnetic tape.

For example, it is assumed that three information processing devices, that is, information processing devices 10A and 10B, in addition to the information processing device 10, can be used in a case where data is read out from the magnetic tape 30 housed in the tape library 20, as shown in FIG. 9. The information processing devices 10, 10A, and 10B are connected to the tape drives 40A, 40B, and 40C, respectively, and are connected to the terminal device 60 via the network 50. The information processing devices 10, 10A, and 10B read out data from the magnetic tapes 30A, 30B, and 30C housed in the tape library 20, respectively, and transfer the data to the terminal device 60, in response to a data read-out request from the terminal device 60.

The number of data divisions is made three according to the number of the information processing devices (three) available at the point in time of data read-out, so that the information processing devices 10, 10A, and 10B can read out the pieces of partial data in parallel from the magnetic tapes 30A, 30B, and 30C on which the pieces of partial data are recorded. For example, since each of the information processing devices 10, 10A, and 10B reads out data from the magnetic tape and transfers the data to the terminal device 60, in parallel, even in a case where the transfer rate of data transmitted from each of the information processing devices 10, 10A, and 10B to the network 50 is 100 MB/sec, the terminal device 60 can receive the data at a rate of 300 MB/sec. The number of information processing devices available at the point in time of data read-out may be input by, for example, the user via the input unit 105.

Alternatively, the information processing device 10 may make a size of at least one of the plurality of pieces of partial data different from a size of the other piece of partial data in a case where the number of tape drives (that is, the number of data divisions, which is also the number of pieces of partial data) available in a case where the pieces of partial data are read out from the plurality of magnetic tapes on which the pieces of partial data are recorded is smaller than the number of magnetic tapes on which the pieces of partial data are recorded.

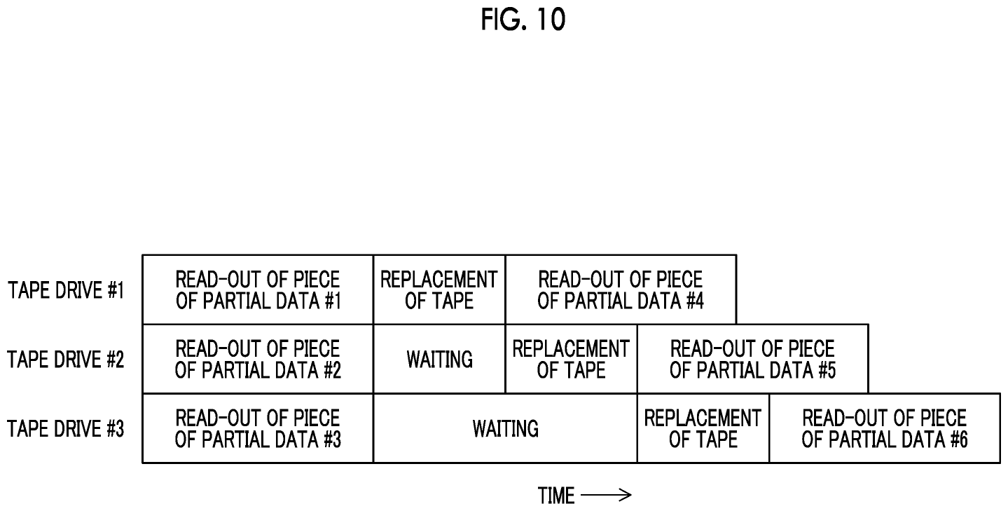

Here, FIG. 10 is a time chart showing an example of the operation timing of each tape drive in a case where the tape drives read out the pieces of partial data in parallel, when the number of tape drives available in a case where the pieces of partial data are read out is three, the number of magnetic tapes on which the pieces of partial data are recorded is six, and the size of the piece of partial data recorded on each magnetic tape is uniform.

As shown in FIG. 10, a tape drive #1 reads out a piece of partial data #1 from a magnetic tape on which the piece of partial data #1 is recorded, a tape drive #2 reads out a piece of partial data #2 from a magnetic tape on which the piece of partial data #2 is recorded, and a tape drive #3 reads out a piece of partial data #3 from a magnetic tape on which the piece of partial data #3 is recorded. The data in respective tape drives #1 to #3 is read out in parallel. In a case where the sizes of the pieces of partial data #1, #2, and #3 are uniform, the read-out of these pieces of partial data is completed at substantially the same timing.

After that, a magnetic tape on which a piece of partial data #4 is recorded is loaded into the tape drive #1, a magnetic tape on which a piece of partial data #5 is recorded is loaded into the tape drive #2, and a magnetic tape on which a piece of partial data #6 is recorded is loaded into the tape drive #3. In a case where the number of tape changers that replace the magnetic tape in the tape drive is one, the magnetic tapes are replaced sequentially as shown in FIG. 10. In this case, the tape drives #2 and #3 are in a waiting state in the period in which the magnetic tape is replaced in the tape drive #1. In a case where the replacement of the magnetic tape in the tape drive #1 is completed, the replacement of the magnetic tape in the tape drive #2 is started. The tape drive #3 is in a waiting state even in the period in which the magnetic tape is replaced in the tape drive #2. In this way, in a case where the number of tape drives available at the time of data read-out is smaller than the number of magnetic tapes on which the pieces of partial data are recorded, that is, in a case where the magnetic tape needs to be replaced (tape change), there is a concern that a waiting time may occur in the tape drive and the effect of shortening the read-out time with parallel read-out of the pieces of partial data may be reduced in a case where the sizes of the pieces of partial data recorded on the magnetic tapes are uniform.

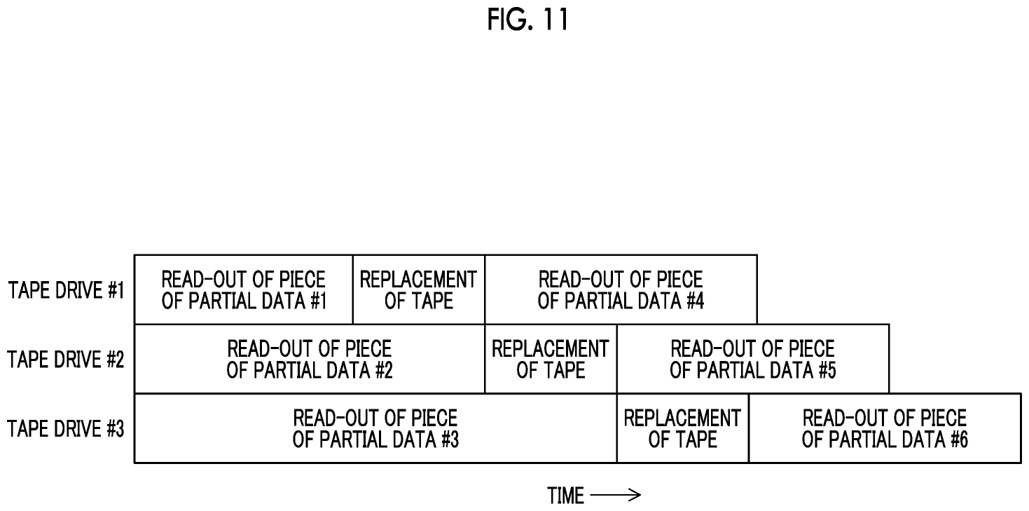

In that respect, as shown in FIG. 11, the sizes of the pieces of partial data recorded on the magnetic tapes are made ununiform, so that it is possible to restrain the occurrence of waiting time in the tape drive. In the example shown in FIG. 11, the size of the piece of partial data #1 is smaller than the size of the piece of partial data #2, and the size of the piece of partial data #2 is smaller than the size of the piece of partial data #3. With this, it is possible to continuously read out the pieces of partial data #2 and #3 and to restrain the occurrence of waiting time in the tape drives #2 and #3, in the period in which the read-out of the piece of partial data #1 is completed first and the magnetic tape is replaced in the tape drive #1.

The read-out of the piece of partial data #2 in the tape drive #2 is completed after the replacement of the magnetic tape in the tape drive #1 is completed, so that the waiting time in the tape drive #2 can be eliminated. Similarly, the read-out of the piece of partial data #3 in the tape drive #3 is completed after the replacement of the magnetic tape in the tape drive #2 is completed, so that the waiting time in the tape drive #3 can be eliminated.

The magnetic tapes in the plurality of tape drives can be replaced in parallel by using a plurality of tape changers, and the sizes of the pieces of partial data recorded on the magnetic tapes are made ununiform even in an environment where waiting time does not occur so that the period during which the number of parallel processing in parallel read-out of the pieces of partial data is the largest can be shortened, which is preferable from the viewpoint of distributing the load of the information processing device 10.

Further, in the above-described embodiment, for example, the following various processors can be used as the hardware structure of a processing unit that executes various types of processing, such as the acquisition unit 12, the specification unit 14, the division unit 16, and the control unit 18. The above-described various processors include, for example, a programmable logic device (PLD) which is a processor having a changeable circuit configuration after manufacture, such as an FPGA, and a dedicated electrical circuit which is a processor having a dedicated circuit configuration designed to perform specific processing, such as an application specific integrated circuit (ASIC), in addition to the CPU which is a general-purpose processor that executes software (programs) to function as various processing units, as described above.

One processing unit may be composed of one of these various processors or a combination of two or more processors of the same type or different types (for example, a combination of a plurality of FPGAs or a combination of a CPU and an FPGA). Alternatively, a plurality of processing units may be composed of one processor.

A first example in which a plurality of processing units are composed of one processor is an aspect in which one or more CPUs and software are combined to constitute one processor and the processor functions as the plurality of processing units, as typified by a computer, such as a client and a server. A second example is an aspect in which a processor that realizes all the functions of a system including the plurality of processing units with one integrated circuit (IC) chip is used, as typified by a system on chip (SoC). As described above, various processing units are formed of one or more of the above-described various processors as the hardware structure.

Further, as the hardware structure of these various processors, more specifically, an electric circuit (circuitry) in which circuit elements, such as semiconductor elements, are combined can be used.

Further, in the above-described embodiment, the aspect in which the information processing program 110 is stored (installed) in the storage unit 103 in advance has been described, but the disclosed technique is not limited thereto. The information processing program 110 may be provided in a form of being recorded on a recording medium, such as a compact disc read only memory (CD-ROM), a digital versatile disc read only memory (DVD-ROM), and a Universal Serial Bus (USB) memory. Alternatively, the information processing program 110 may be downloaded from an external device via a network.

The disclosure of JP2020-035309 filed on Mar. 2, 2020 is incorporated herein by reference in its entirety. In addition, all documents, patent applications, and technical standards described in the present specification are incorporated in the present specification by reference, to the same extent as in the case where each of the documents, patent applications, and technical standards is specifically and individually described.

What is claimed is:

1. An information processing device comprising:
at least one processor,
wherein the processor
divides data with a certain size or larger, which is specified on the basis of a read-out history, into a plurality of pieces of partial data, and
performs control to distribute and record the plurality of pieces of partial data with respect to a plurality of magnetic tapes, respectively.

2. The information processing device according to claim 1,
wherein the processor divides data, which is read out a certain number of times or more within a certain period, into the plurality of pieces of partial data.

3. The information processing device according to claim 1,
wherein the processor makes a size of at least one of the plurality of pieces of partial data different from a size of the other piece of partial data in a case where the number of tape drives available in a case where the pieces of partial data are read out from the plurality of magnetic tapes on which the pieces of partial data are recorded is smaller than the number of magnetic tapes on which the pieces of partial data are recorded.

4. The information processing device according to claim 2,
wherein the processor makes a size of at least one of the plurality of pieces of partial data different from a size of the other piece of partial data in a case where the number of tape drives available in a case where the pieces of partial data are read out from the plurality of magnetic tapes on which the pieces of partial data are recorded is smaller than the number of magnetic tapes on which the pieces of partial data are recorded.

5. The information processing device according to claim 1,
wherein the processor determines the number of divisions in a case where the data is divided into the plurality of pieces of partial data, on the basis of a requested value of a data transfer rate in a case where the data is read out from the magnetic tape.

6. The information processing device according to claim 4,
wherein the processor determines the number of divisions in a case where the data is divided into the plurality of pieces of partial data, on the basis of a requested value of a data transfer rate in a case where the data is read out from the magnetic tape.

7. The information processing device according to claim 1,
wherein the processor determines the number of divisions in a case where the data is divided into the plurality of pieces of partial data, on the basis of an assumed value of an error rate in a case where the data is read out from the magnetic tape.

8. The information processing device according to claim 6,
wherein the processor determines the number of divisions in a case where the data is divided into the plurality of pieces of partial data, on the basis of an assumed value of an error rate in a case where the data is read out from the magnetic tape.

9. The information processing device according to claim 1,
wherein the processor determines the number of divisions in a case where the data is divided into the plurality of pieces of partial data, on the basis of the number of information processing devices available at a point in time of data read-out, the information processing devices processing data read out from the magnetic tape.

10. The information processing device according to claim 6,
wherein the processor determines the number of divisions in a case where the data is divided into the plurality of pieces of partial data, on the basis of the number of information processing devices available at a point in time of data read-out, the information processing devices processing data read out from the magnetic tape.

11. An information processing method executed by a processor provided in an information processing device, the method comprising:
dividing data with a certain size or larger, which is selected on the basis of a read-out history, into a plurality of pieces of partial data; and
performing control to distribute and record the plurality of pieces of partial data with respect to a plurality of magnetic tapes, respectively.

12. A non-transitory computer-readable storage medium storing an information processing program for causing a processor provided in an information processing device to execute a process comprising:
dividing data with a certain size or larger, which is selected on the basis of a read-out history, into a plurality of pieces of partial data; and
performing control to distribute and record the plurality of pieces of partial data with respect to a plurality of magnetic tapes, respectively.
